(19) United States
(12) Patent Application Publication
(10) Pub. No.: US 2005/0140672 A1
(43) Pub. Date: Jun. 30, 2005

(54) Shader editor and compiler

(76) Inventor: Jeremy Hubbell, Bellevue, WA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 10/782,575

(22) Filed: Feb. 18, 2004

Related U.S. Application Data
(60) Provisional application No. 60/448,316, filed on Feb. 18, 2003.

(51) Int. Cl. G06T 15/50; G06T 15/60

(52) U.S. Cl. 345/426

(57) ABSTRACT

A software application that allows users to create shader definitions using an intuitive graphical user interface. The invention is characterized by an intuitive user interface with a streamlined workflow that non-technical users (artists) are able to understand and utilize without the need to become technically proficient in computer software expression. This interface allows the user to create a shader graphically without writing code, by wiring predefined filter, assembly and property primitives together into a dynamic, directed wire graph. A high level code definer writes an XML (for example) script for the defined wire graph. The output produced by the system is translated into a shader program implemented in a format that is recognized by some other rendering system. Typically this means a shader program represented as a text file containing code in some specific shader language. The system is able to generate output targeted for specific platforms based on a single graphical representation of the shader program created by the user.

### CROSS REFERENCE TO RELATED APPLICATIONS

The present application is related to and takes priority from U.S. Provisional Patent Application Ser. No. 60/448,316, filed Feb. 18, 2003, entitled “Shader Editor and Compiler, commonly owned with the assignee of the present invention, the entire contents of which are expressly incorporated herein by reference.

### FIELD OF THE INVENTION

The present invention is directed to systems and methods for graphical image rendering and compositing and, more particularly, to systems and methods for developing programmable shaders that may be implemented into real-time rendering systems without regard to the rendering system's programming language.

### BACKGROUND OF THE INVENTION

Historically, graphics rendering systems have typically employed the concept of a shader or material to describe color, and various attributes of a color, of a region on the surface of an object. Shaders are commonly implemented as procedural plug-ins which allow different methods of computing a surface color to be substituted, into a procedure, based on the desired affect. A shader plug-in is typically implemented as a program written in a specific shader language, particular to the rendering system that will utilize it.

In the past, only off-line rendering systems allowed for programmable shader descriptions, while real-time rendering systems used a fixed lighting algorithm. Recent advances in graphics hardware have made it possible to incorporate programmable shaders into real-time rendering system environments and have lead to the emergence of a number of different programming languages with which to write these shaders.

Contemporary software applications are, by and large, developed with high level programming languages, such as “C”, and the like. However, in order to create complex visual effects, artists have had to rely on highly restrictive assembly language programs that are written directly to graphics hardware. Accordingly, an artist is required to spend a considerable amount of time and effort in programming his or her computer; time and effort that could be better spent in creating visually exciting graphics images.

Although we live in a world in which professional, high-end graphics and visual communication are common place (both on television and in films) it is often quite difficult for an artist, lacking significant programming skills and training, to create such graphics simply and easily. In particular, there are no tools currently available that allow an ordinary user to create various shader definitions utilizing a simple, intuitive graphical user interface in order to create polished, high-impact visual media in a timely or cost-effective manner. Moreover, despite the broad appeal and large in information band width inherent in well-produced graphical presentations, there are no systems or methods in the current marketplace, even for professional graphic artists, that efficiently convert various programmable shader descriptions into shader programs for real-time hardware.

### SUMMARY OF THE INVENTION

In particular, the invention is directed to a software application (termed Baku herein for purposes of convenience) that allows users to create shader definitions using an intuitive graphical user interface. The invention is characterized by certain particular features; an intuitive user interface with a streamlined workflow that non-technical users (artists) are able to understand and utilize without the need to become technically proficient in computer software expression. This interface allows the user to create a shader graphically without writing code.

A user is able to create an infinite number of unique shaders. This is different from simply changing the parameters to a single shader. The user will be able to actually define new shading algorithms utilizing Baku's graphical representation. The output produced by Baku is characterized as a shader program implemented in a format that is recognized by some other rendering system. Typically this means a shader program represented as a text file containing code in some specific shader language. Baku is able to generate output targeted for specific platforms based on a single graphical representation of the shader program created by the user. Target output formats can be added as needed, however for ease of explanation, the invention specification focus will be placed on shader programs for real-time hardware such as programs in the HLSL or Cg language format.

### DESCRIPTION OF THE DRAWINGS

These and other features, aspects and advantages of the present invention will be more fully understood when considered with respect to the following specification, appended claims and accompanying drawings, wherein:

FIG. 1 is a simplified, semi-schematic representation of examples of filters, properties and assemblies in accord with the present invention;

FIG. 2 is a simplified, semi-schematic representation of a material assembly structure;

FIG. 3 is a simplified, semi-schematic representation of vertex and pixel shader wire graphs;

FIG. 4 is . . .

### DESCRIPTION OF THE INVENTION

Specifically, the invention is directed to a software application that allows graphics artists to create shader definitions using a simple, intuitive graphical user interface. The invention is characterized by certain particular features; and intuitive user interface with a streamlined workflow that non-technical users, such as graphics artists, are able to understand and utilize without the need to become technically proficient in computer software programming. This interface allows the user to create a shader graphically, modify all of its parametric definitions, and view the resulting object, all without writing code.

A user is able to create an infinite number of unique shaders. It should be understood that this is different from simply changing one or more of multiple parameters to a single shader. In accordance with the invention, a user is able to actually define new shading algorithms utilizing the invention's graphical representation. The output of the system is characterized as a shader program implemented in a program that is recognized by some other rendering system. Typically, this might be characterized as a shader program, represented as a text file, which contains code in some specific shader language, with the generated output targeted for specific platforms based on a single graphical representation of the shader program created by the user.

In particular, a shader, editor and compiler, in accord with the present invention, implements the paradigm of a wire graph. In terms of the invention, the wire graph is a directed acyclic graph (DAG) of nodes that are connected by what are commonly termed wires. Wires connect to nodes and have a direction that represents the direction of the flow of data. When discussing two nodes, connected by a wire, one refers to the upstream node as the source and the downstream node as the sync. The user creates nodes and uses wires to establish connections between nodes, the end result being a graphical representation of a model that describes functional elements and how they are evaluated. In other words, the wire graph forms a model of a shader editor program in a manner similar to a computer program data model and flow diagram.

As will be understood by those having skill in the art, directed acyclic graphs are directed graphs with no cycles. Directed acyclic graphs are part tree, part graph and have many applications, such as those involving precedence among “events”. Many problems in graphical description become relatively simpler, when utilizing directed acyclic graphs, particularly expression tree evaluation because of DAG's ability to be topologically sorted using depth-first search.

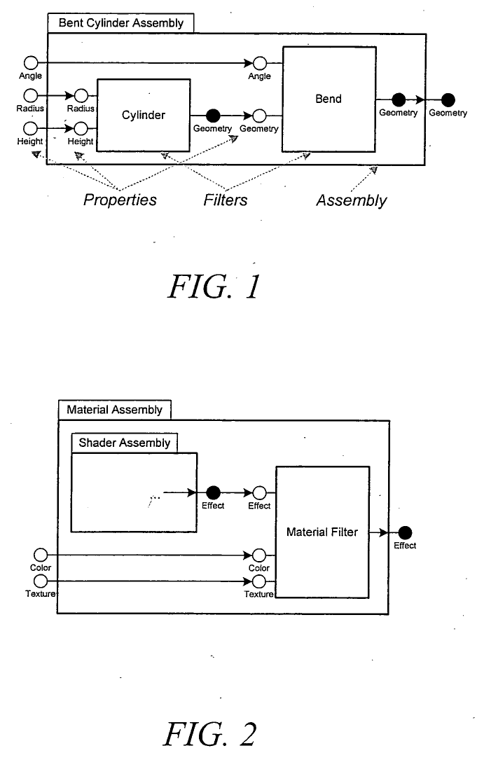

By way of background, and with reference to the exemplary embodiment of FIG. 1, there are, typically, three types of graph nodes; assembly nodes, filter nodes and property nodes. An assembly node 10 might be appropriately described as a grouping of graph elements into a single unit for organizational purposes. A particular assembly node might have any number of inputs and/or outputs that are “visible” to the environment outside of the assembly node. Additionally, an assembly 10 might also contain other types of nodes as internal elements which may not necessarily be visible to the environment outside the assembly. Characteristically, assemblies may contain filters, properties, and even other, nested assemblies which might themselves incorporate various other graph nodes.

The elements of an assembly form what is termed a subgraph (which itself may or may not have its various inputs and outputs completely connected to one another). Inputs and outputs of the elements in this contained subgraph can be connected to the inputs/outputs of the assembly, as well as to the inputs/outputs of contained nodes. As will be described in greater detail below, this property allows a subgraph to be collapsed into a single representational unit, with selected components exposed to the external environment as assembly inputs and outputs. As mentioned above, assemblies may be nested, such that one assembly is able to contain an other assembly as a complete internal element.

A filter node (or “filter”) 12 includes a collection of inputs and outputs (typically a single output) and represents a function that computes an output value based on input values or properties. It should be further understood that a filter input is able to be wired to function as either a source or a sync. When wired as a sync, a wire connection provides a value or parameter from some other node to the filter input, where the value or parameter is used by the filter's computation function. Conversely, when a filter's input is wired as a source, the filter does not perform its computational function on the input value, but rather acts as a simple pass-through, thereby providing the value of an input to a downstream element as though it were an additional output. Necessarily, however, the primary outfit of a filter may only be wired as a source.

A property node, indicated generally at 14, typically represents a single data value, or parameter, such as height, a radius, an angle, a geometry definition, and the like. A property node may be used as an input to a filter, or it may stand alone as an element in a sub-assembly, assembly, or the graph. A property node may be wired as either a source or a sync, but, irrespective of whether it is wired as a sync, it always contains a value that it can provide to any client element to which it is wired as a source. This particular contained value is commonly referred to as a “seed value”.

In the context of the exemplary embodiment of FIG. 1, a bent cylinder assembly 10 can be seen as comprising a number of graph element nodes which are coupled together in order to define a bent cylinder. The bent cylinder assembly 10 outputs a geometry 15 based upon input property definitions of angle 16, radius 17, and height 18. Although angle, radius and height are properties defining the inputs of the bend cylinder assembly 10, it will be seen that the radius 17 and height 18 properties are wired as sources to the cylinder filter 12, which mathematically computes a cylinder geometry based upon these inputs.

The angle property 16 is wired as a source to a bend filter 13 which also receives the geometry property from the cylinder filter 12. The bend filter 13 applies the angle property to the cylinder geometry and outputs a bent cylinder 15. The “bent cylinder assembly” is thus the combination of the various filters and properties that make up a “bent cylinder” object.

In accordance with the invention, a wire graph, or wire graph portion, can be implemented as an active functional element or a passive data structure. Within an active functional wire graph, a filter (or assembly) is able to query its input properties in order to retrieve their values. In turn, this causes property elements to evaluate their own wires (if indeed they are wired) which may, in turn, trigger evaluation of other filters, in accordance with the tree-like structure of the directed acyclic graph nature of the system. Once input properties are queried and retrieved, the filter combines the value of its input properties in order to produce an output that is made available to client elements which are, in turn, wired downstream from the filter.

Conversely, a passive wire graph is simply and purely a representational data structure that depicts a functional relationship between various elements but is not active in the computation of those functions. For example, a shader graph in the context of the invention is a portion of the wire graph that is passive and purely representational. The shader graph represents a shader program by depicting how inputs are combined mathematically in order to produce an output surface color, thereby creating an abstract model of a shader program. The shader graph is not directly evaluated by the invention but rather interpreted and converted into a shader program suitable for a particular output target platform. The output shader program is then able to run on its own on the host target platform.

The system also allows creation of a seen wire graph in order to define an environment in which shaders (or shader results) are previewed. A seen wire graph is an active, functional wire graph that is evaluated in software as opposed to being interpreted into a shader program in some target language. Seen elements, such as geometry, lights, cameras, and the like, are implemented by filters that combine values from their inputs to produce an output, as described above. Utilizing the example of FIG. 1, a geometry-producing filter such as a cylinder may have a radius and height input that the filter uses to generate cylinder geometry of the appropriate size. A seen is rendered by evaluating this and other filters in order to obtain the geometry, lights, camera angles, and materials suitable for the rendered view.

Turning now to FIG. 2, a “material” in The system is structured to include the purely representational shader wire graph in addition to components in the scene wire graph. The shader wire graph is encapsulated in an assembly called the shader assembly. This shader assembly is placed into another assembly that represents the material (the material assembly) along with a material filter. Each material contains properties that specify values corresponding to variables in the shader program. Several materials may refer to the same shader assembly, each with its own set of properties that correspond to variables in the shader. Thus, a shader assembly essentially defines a program while the material assembly provides the data (values for parameters) for that program. Just as a program can be run with different sets of data, a shader assembly can be used with different materials.

The properties of the material assembly are available to be wired to other parts of the scene wire graph. This portion of the wire graph is not interpreted into a shader program but is instead run in software directly. For example, a subgraph of filters could be wired together to produce a color used as a value for a variable provided to the shader program. However, from the point of view of the shader program, this value is static because it is not computed as part of the computation of the shader program.

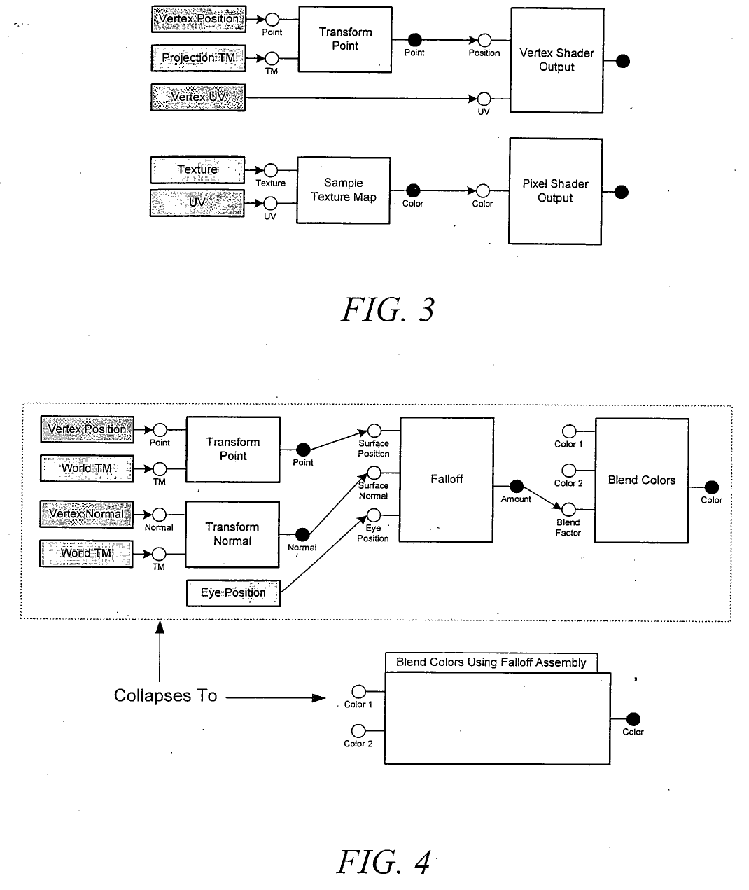

As can be understood from FIG. 3, the shader wire graph uses the same elements as a scene wire graph (filters, properties, and assemblies) to build a graphical model of a shader program. This model is focused on the current needs of real-time hardware rendering but is also applicable to software-based offline rendering. The shader graph is made up of two subgraphs. One represents the per-vertex portion of the program and one represents the per-pixel part of the program. The per-vertex program gets vertex data as input and produces a collection of output values. The per-pixel program gets the output of the vertex program as input and produces an output surface color. Both offline software rendering and real-time hardware rendering have these two stages as part of their process of rendering. First vertices are processed (the vertex program) and then the result is used to rasterize surface elements (often triangles) to produce surface fragments to be shaded by the pixel program.

Both the pixel and vertex program graphs have some common elements. Properties can be created to represent input variables to the shader program. There are two types of variables: varying inputs, such as “Vertex Position” in FIG. 3, and uniform inputs, such as “Projection TM”. Varying inputs change as the shader program process each element while uniform inputs are constant as an object is rendered. For example, the vertex data (varying input) passed to a vertex program varies as each vertex is processed while the world transformation matrix (uniform input) is constant for each vertex processed. The varying inputs to a pixel program are the outputs of the vertex program.

A shader output filter, such as the “Pixel Shader Output” of FIG. 3, represents the collection of data that is output from a shader program. Each input property of this filter represents a component that is output from the shader program. A vertex program must at least output a position, but can also output other elements in addition. A pixel program always just outputs a color that represents the color of the surface being shaded.

The input variable properties are wired to filters (“Transform Point” of FIG. 3) to form a graph that is ultimately connected to the shader's output filter. Each filter represents a function or operation. This could be a mathematical operation like multiplication, addition, or a dot product. Or it could represent other types of operations such as a function that looks up and retrieves a pixel from a texture map. There are also filters to convert data types or extract a component of a data type.

The user creates these elements and wires them together to form a shader graph for the pixel and vertex shader programs. The vertex and pixel shader graphs appear as unconnected graphs, although the varying input properties of the pixel shader refer to the same data elements as the outputs of the vertex shader. Portions of these shader graphs can be bundled up into an assembly and collapsed to appear as a single element. This has two purposes: to reduce visual complexity of the graph so the graph can be better visualized and to create a computational unit that can be reused in other shaders through a process called templatization.

A portion of a wire graph encapsulated in an assembly can be templatized to allow it to be reused. This process records the structure of the contents of the assembly so it can be used as a template to create another instance of that assembly. Entire shader graphs can be templatized or just subgraphs.

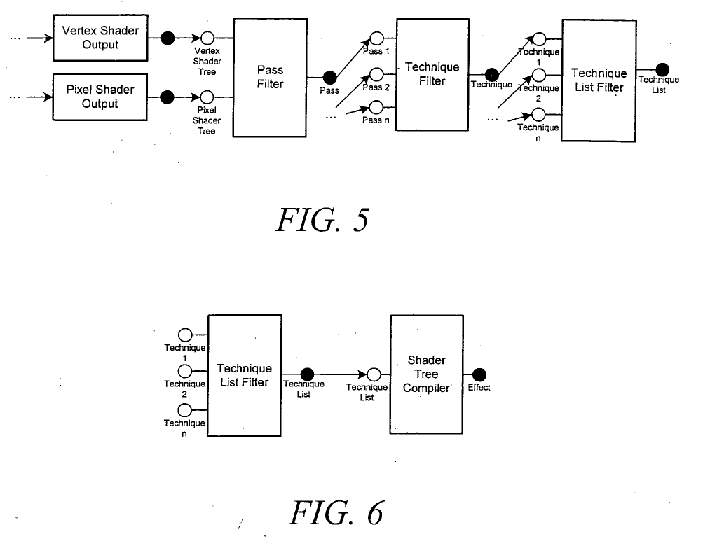

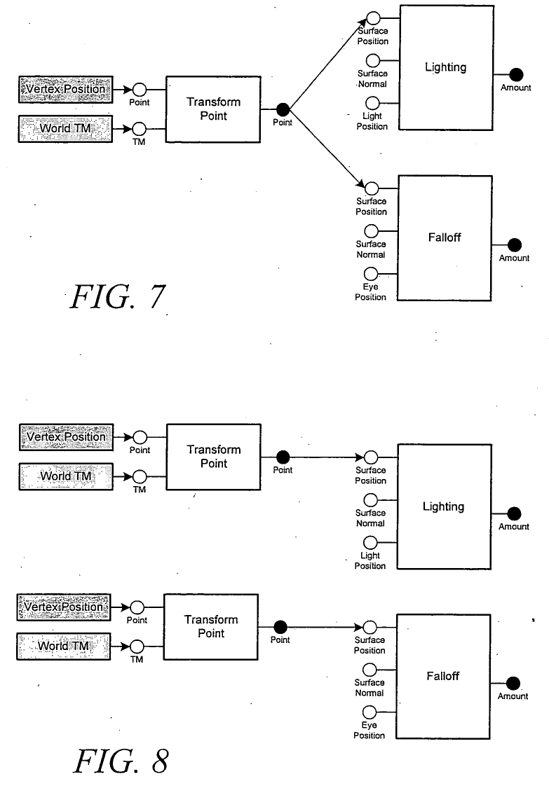

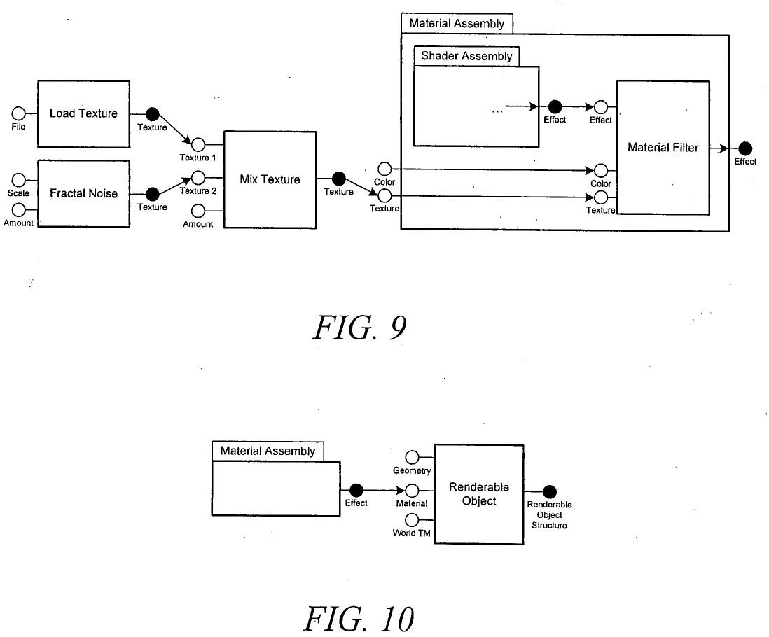

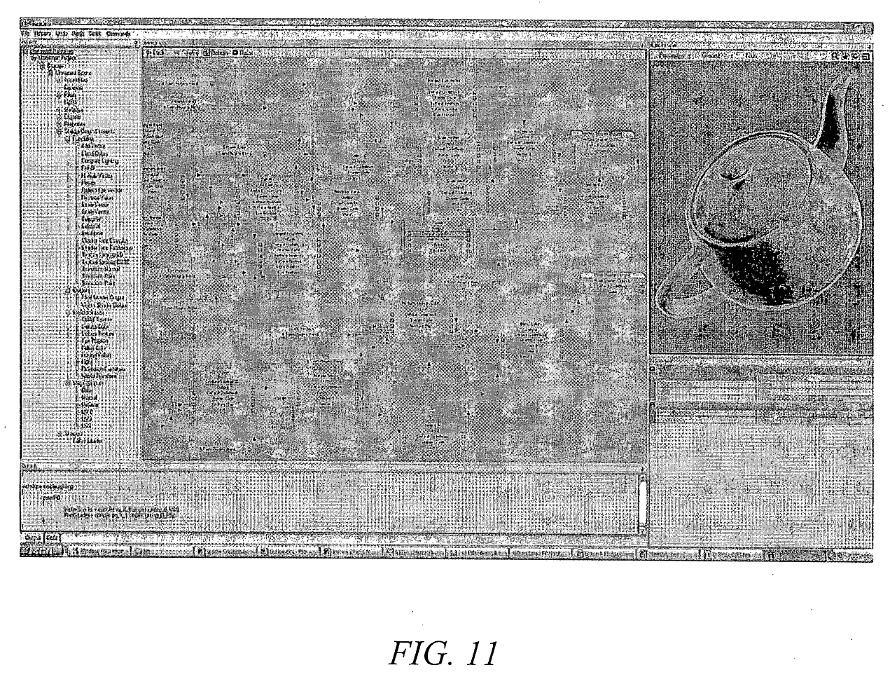

Using the process of collapsing subgraphs into single units (assemblies) and templatizing these units for reuse, effectively creates different levels of complexity at which a user can choose to work because a user can use these pre-made units as building blocks for their own shader graphs, as shown in the exemplary embodiment of FIG. 4. This allows an artist with little technical knowledge to work at a high level using pre-made assemblies that encapsulate the details (and hide them from the user) or a more technical user to work with low level filters for complete control over the shader program. Also, an artist with a small amount of technical knowledge can work with medium level assemblies that strike a compromise between hiding complexity and providing more control so these users can create a wide variety of shaders without programming.

Filters represent an operation or mathematical function of some sort. They store this representation in a code fragment written in an intermediate language. This intermediate language (IL) is interpreted by compilers to produce output in a particular target language. As such, the IL is a superset of all possible output languages.

In some cases a particular target language may not support a concept or function represented by the IL in which case that compiler won't be able to produce an output and will generate an error. The system will identify filters that are not supported by the target indicated by the user so the user knows in advance not to use these filters.

A large set of filters representing all of the common mathematical functions and operations will be supplied with The system, although a user can extend this set of filters by implementing their own filters. The implementation of a shader filter requires that all input properties are identified and that the IL code fragment representing the operation of the filter is provided. The user will not have to provide code in the IL format but instead can provide code in some known existing format such as HLSL or Cg. Internally The system will convert the code provided by the user into IL code to be stored with the filter. The filter will also retain the original non-IL code the user provided so if the user later wants to modify that code they can modify the original and The system will reconvert it to IL.

Given a shader filter with its IL representation, it is possible that the same result can be expressed by a subgraph of filters with simpler IL representations. The system will be able to decompile IL into such a subgraph if one exists. This allows a user to provide a block of code for a filter and have The system turn that code into a graph comprised of primitive filters which the user (or another user) could modify graphically by wiring to additional filters or variables.

The shader graph is a passive, representational wire graph that is interpreted by a shader graph compiler to produce code in a particular output language (such as HSLS or Cg for example). Different compilers that each produce output in a different format can interpret the same shader graph. As new languages emerge, new compilers can be written to add support for these new languages. Because a universal IL defines the shader filter's operation, the shader graph is not tied to any particular language.

The interpretation of a shader graph by a compiler can be broken out into the following steps. A shader graph can define multiple methods for achieving a particular look called techniques. The client of the shader can decide which technique to use based on different criteria. It is common to create different techniques that support different levels of hardware compatibility. In this case one technique may refer to a more complex shader program that requires modern hardware to support it while another technique refers to a shader program with less complexity, but is supported on a wider range of hardware.

Within a particular technique, there may be multiple shader programs executed in individual passes. This allows a shader program that utilizes all the resources of the hardware (for example the maximum number of supported simultaneous textures) to execute in one pass followed by another shader program that also has all the resources of the hardware available to it in another pass.

As shown in the exemplary embodiment of FIG. 5, techniques and passes are represented in the shader graph by filters that combine inputs to produce an output technique list. A pass filter combines the pixel and vertex shader trees to produce a pass structure. A technique filter combines a collection of passes (any number of passes) to produce a technique structure. Finally, a technique list filter combines a collection of techniques (any number of techniques) to produce a technique list. The technique list, as indicated in FIG. 6, is the data that is given to the compiler filter as input from which the compiler will generate the output shader program code. Given the technique list, the first step of the compiler is to identify all the techniques and passes and generate the appropriate declarations.

Uniform variables are global variables that can be referred to by any filter in any of the shader graphs. Their values will be set by the software hosting the shader program and remain constant while the shader program is executed. The compiler traverses all the shader trees in the given technique list and identifies these variables so that it can make the appropriate declarations for them. It also stores descriptors describing each uniform input and it provides these descriptors to the material filter. The material filter matches up the uniform variables with the material's properties and uses the values of those properties to provide a value for the uniform variables. Some uniform variables are not associated with a property on the material but instead derive their value from a predefined source such as world transform, viewer position, etc. The user identifies uniform variables that are to be mapped to one of these known quantities in advance by setting a tag called a semantic. Uniform variables for which the user has not associated a semantic are assumed to have matching material properties from which they can derive their values.

Each pixel or vertex shader tree referred to by the various passes is identified and code in the target output language is generated. This involves identifying the varying inputs to the shader program and generating the appropriate function declaration. The shader output filter describes the data structure computed by the shader function (each input property of the output filter is a data member in this structure). This output structure is also declared at this stage.

The body of the code of the shader function is generated by recursively traversing the filter graph representing that shader. For each filter, the IL fragment associated with that filter is interpreted and converted into the target language. The IL fragment refers to the input properties of the filter and therefore code to compute those values must be generated as well. To do this, a local variable is declared in the output code to hold the result and code to compute that result is generated. If the input property in question is wired to another filter, code is recursively generated that computes the result of that filter. If the input property is set to a constant value, then that value can be placed in the output code where it is referenced.

As can be understood from the alternative illustrations of FIGS. 7 and 8, the compiler can be optimized in a couple of ways. If multiple inputs to filters are wired to the same subgraph, code that produces the result of that subgraph only needs to be generated and output in the final program once. This avoids creating a program that generates the same value twice. Similarly, two individual subgraphs may be equivalent and referred to by two separate inputs. In this case it would also be optimal to only generate and output the code to produce the value represented by the equivalent subgraphs once. The compiler in The system will detect these cases and generate optimized code. This leaves the user free to construct the shader graph without concern for these operations.

The system application provides a workspace in which the user can create shaders. Within The system, the user can specify object, lights, and cameras to be used to render an image showing the shader in use in the context of a scene. While a user may ultimately export the output code produced by the shader compiler for use within another application or rendering environment, The system provides an environment to host the shader program while it is in development by the user. This allows the user real-time interactive feedback as they make changes to the shader program.

The material structure in The system previously described allows the user to construct a scene wire graph that produces values used to set the value of uniform input variables. A series of scene graph filters could be wired together that form a compositing tree for a texture map for example, the result of which is used as a texture uniform variable in the shader program. The scene graph is part of the environment provided by The system to host the shader program, but is not converted into shader code as part of the output shader program. For example, the exemplary embodiment of FIG. 9 depicts a subgraph, that is part of the scene wire graph, that computes a texture to be used by the material.

The shader compiler generates code in a target language that can be exported for use in other systems, but in addition the shader compiler (encapsulated in the shader assembly) can by used inside the system application. A renderable object filter, depicted in the exemplary embodiment of FIG. 10, combines the elements needed to render a piece of geometry into a data structure given to the renderer. These elements include geometry, a world space transformation matrix, and a structure representing the shader program provided by the material filter called an effect.

The effect structure encapsulates the code produced by the shader tree compiler along with a description of the uniform input variables for which values need to be provided before rendering with the effect. The material filter also associates properties with some of these uniform inputs and stores this association with the effect structure.

The render is given a scene that contains a number of renderable object filters. The render evaluates each filter to get the geometry, world space transform, and effect structure. The effect structure contains the code in a target language format generated by the shader tree compiler and the renderer gives this code to another third party compiler for that target language (such as the Cg compiler or Microsoft's HLSL compiler built into DirectX). The result is a shader program compiled for the hardware on the user's machine that allows the shader to be viewed.

The renderer is also responsible for setting the values of the uniform variables using APIs provided by the host rendering system (such as Direct X). The render retrieves the values for these variables from properties in the case where the material has associated properties with the uniform inputs. In the case where a semantic was used to associate a known parameter, the render provides the value for that parameter.

The result is that an image is rendered interactively that represents the current state of the shader program as the user builds it. The user is able to preview the shader using any target language as long as a shader tree compiler and render API is provided that supports that language. The system will initially support compilers for HLSL and Cg and a renderer (Direct X and OpenGL) that supports shader programs written in either of those languages.

The system is a software application that allows a user to construct a graphical representation of a shader program. The representational shader graph is independent of any particular shader language however different compilers that are part of The system can interpret that graph and produce a shader program in the format of a particular target shading language. As new languages emerge, new compilers can be plugged into The system to support these new languages.

The shader graph is kept independent of any particular shader language because the atomic units of functionality, the shader filters, represent their corresponding operation in an intermediate language that is a superset of all languages.

The system, in accord with the invention, defines an application which provides an interactive environment in which users can preview their shaders in real-time to get immediate feedback as they construct them. The combination of the ease of use of the graphical representation, the ability to collapse complexity into units of functionality (assemblies), and the ability to get real-time interactive feedback makes the creation of shaders accessible to those users who previously didn't have the technical ability to write shader code and provides an efficient and powerful authoring environment to those with more technical ability.

1. A computer system for defining a representation of a shader in graphical form, the system comprising:
a first collection of graphical objects, each object having at least one input and at least one output, each of the first graphical objects defining a graphical function;
a second collection of graphical objects, each object having at least one input and at least one output, each of the second graphical objects defining a graphical parameter;
a set of directed wires, a wire of the set coupling between at least one output of the second graphical object set and at least one input of the first graphical object set;
a code definer operative to express a wire coupling between a first and second graphical object, the code definer further operative to identify each graphical parameter and graphical function coupled by the wire; and
a compiler, operative to translate and compile code defined by the definer into a selected program language suitable for operating and controlling a hardware shader.

2. In a computer system, a method for defining a representation of a shader in graphical form, the method comprising:
defining first collection of graphical objects, each object having at least one input and at least one output, each of the first graphical objects defining a graphical function;
defining second collection of graphical objects, each object having at least one input and at least one output, each of the second graphical objects defining a graphical parameter;
coupling a directed wire between at least one output of the second graphical object set and at least one input of the first graphical object set;
expressing a wire coupling between a first and second graphical object in a representational software language;
expressing each graphical parameter and graphical function coupled by the wire in said representational language; and
translating and compiling the representational software language into a selected program language suitable for operating and controlling a hardware shader.
